(19) United States
(12) Patent Application Publication
(10) Pub. No.: US 2013/0290421 A1
(43) Pub. Date: Oct. 31, 2013

(54) VISUALIZATION OF COMPLEX DATA SETS AND SIMULTANEOUS SYNCHRONIZATION OF SUCH DATA SETS

(71) Applicant: TOUCHTABLE, INC., Pasadena, CA (US)

(72) Inventors: James BENSON, Pasadena, CA (US); James LAMANNA, Los Angeles, CA (US); Braddock GASKILL, South Pasadena, CA (US); David DOUGLAS, Concord, MA (US); Scott CAMERON, Pasadena, CA (US)

(73) Assignee: TouchTable, Inc., Pasadena, CA (US)

(21) Appl. No.: 13/865,886

(22) Filed: Apr. 18, 2013

Related U.S. Application Data
(60) Provisional application No. 61/639,780, filed on Apr. 27, 2012.

(51) Int. Cl. G06F 15/163

(52) U.S. Cl. CPC G06F 15/163
USPC 709/204

(57) ABSTRACT

Visualization of relatively complex data sets and the simultaneous synchronization of such data sets across both a network and to different areas having different capabilities is disclosed, especially in connection with session structure, synchronization, synchronized control of imagery, and restoring synchronization to a predefined tour.

### CROSS REFERENCE TO RELATED APPLICATIONS

This application claims priority to U.S. provisional patent application Ser. No. 61/639,780, filed Apr. 27, 2012, which application is incorporated herein in it entirety by this reference thereto.

### BACKGROUND OF THE INVENTION

1. Technical Field

The invention relates to collaboration systems. More particularly, the invention relates to the visualization of relatively complex data sets and the simultaneous synchronization of such data sets across both a network and to different areas having different capabilities.

2. Description of the Background Art

Collaboration systems, such as those offered by GoToMeeting, allow the desktop view of a host computer to be broadcast to a group of computers connected to the host through the Internet. Such systems maintain a common image, e.g. of a moderator's desktop, on a central server and stream that image as it is updated to each participant in a collaborative session. This requires a relatively robust and speedy server and ample bandwidth between each of the participants and the server, such that the image can be sent to the participants and simultaneously viewed without too much conspicuous latency. Usually, neither the processor is powerful enough, nor is the bandwidth adequate for the task, and such sessions are at best sluggish. This fault of such systems is particularly pronounced where detail imagery is concerned with free collaboration with regard to such imagery by all session participants.

### SUMMARY OF THE INVENTION

The invention relates to the visualization of relatively complex data sets and the simultaneous synchronization of such data sets across both a network and to different areas having different capabilities. Specific embodiments of the invention concern session structure, synchronization, synchronized control of imagery, and restoring synchronization to a predefined tour.

“Session structure” concerns the structure that is used to establish a session and share data between clients during the session. An embodiment concerns sharing data among a plurality of clients by initiating a session with one or more participating clients, establishing one or more channels within said session, allowing one or more of said participating clients to subscribe to each of said channels, and sharing data between said clients via each of said channels.

In a further embodiment, each of said channels is characterized by a channel type, and each of said participating clients uses said channel type to determine whether it should subscribe to a channel. In further embodiments, the channel type is associated with a data schema.

In embodiments, the channels comprise one or more mailbox channels, wherein each of said mailbox channels is owned by a single participating client among said participating clients, and wherein each of said mailbox channels enables private transmission of data to said single participating client.

In embodiments, the system maintains a list of eligible clients, that, with proper authentication, can join said session as participating clients.

In another embodiment, one or more of said channels exchanges information for controlling the behavior of an application operating on one of said clients, makes a local copy of said state, makes changes to said local copy to produce a forked state, and requests that said server merge said forked state into said state.

Further, in such embodiment one of said clients, acting as a session moderator, approves said forked state prior to said server merging said forked state.

In another embodiment, the system maintains a history of prior states. In such case, one or more of said clients can request that said server revert said state to a prior state within said history of prior states; said server maintains said history; and/or one or more of said clients maintains said history.

“Synchronization” concerns the manner in which information is synchronized in the system. An embodiment concerns synchronizing data in a system having a server, one or more clients, and a session maintained by said server. The session is initiated by a first of said clients and maintained by said server, wherein said session is determined by a state comprising one or more key value pairs, wherein any one of said clients can submit changes to one or more of said key-value pairs to said server, and wherein said server propagates said changes to other clients.

Further, in such embodiment said session is joined by one or more of said clients other than said first of said clients.

In a further embodiment, said changes are propagated in response to polling by said other clients.

In a further embodiment, said server actively notifies said other clients of said changes.

In a further embodiment, any one of said clients can make a local copy of said state, make changes to said local copy to produce a forked state, and request that said server merge said forked state into said state. In such case, one of said clients, acting as a session moderator, approves said forked state prior to said server merging said forked state.

In a further embodiment, said system maintains a history of prior states. In such case, one or more of said clients can request that said server revert said state to a prior state within said history of prior states; said server maintains said history; and/or one or more of said clients maintains said history.

“Synchronized control of imagery.” Many collaborative applications, e.g. video games, desktop conferencing systems, provide a sense of a shared environment with which and within which physically distributed participants can interact. Actions of one participant result in changes within the environment that are replicated within the environment as rendered for each of the other participants. For example, an enemy neutralized by one player in a multiplayer online video game is removed from the shared environment as rendered for all players. Similarly, words written on a virtual whiteboard by one participant within a desktop conference are visible on the virtual whiteboard as rendered for all participants. The herein disclosed system provides similar functionality for a shared environment in which physically distributed users explore geospatial information in a synchronized manner. Specifically, a user can annotate the displayed information, and the resulting annotations can be viewed by other participants. However, the herein disclosed system provides a deeper sense of collaboration by providing the participants with synchronized navigational control of the geospatial information. Control inputs, e.g. pans, zooms, or rotations, of one user synchronously update the viewpoint of other users. In the case of the herein disclosed system, the viewpoint most directly corresponds to so-called camera parameters, e.g. location, orientation, and angular field of view, used in rendering the geospatial information. However, for purposes of the invention herein, a viewpoint also includes such things as the visibility of imagery layers, a particular Web page within a series of web pages, e.g. a website, an active slide within a Web presentation, and a current region of interest within a document, e.g. an image file.

“Restoring synchronization to a predefined tour” concerns a Sync Button that allows a follower of a tour, led by a presenter, to deviate from a particular view within the tour. Upon pressing the button, the follower is immediately returned to the then current view within the tour. This allows the follower to explore the area surrounding a tour stop independently without fear of being irrevocably dropped from the tour. For purposes of the invention herein, views include, inter alia, slides or other discretely sequential AV materials in a video conference Web meeting.

This embodiment of the invention provides synchronized display of geospatial information. This includes loading a tour comprising a set of predetermined views of said geospatial information; receiving inputs from a leader operating a master client; receiving inputs from a follower operating a slave client; in response to said inputs from said leader, displaying in a synchronized manner, a first current view, from within said set of predetermined views, at said master client and said slave client; in response to said inputs from said follower, manipulating said initially current view at said slave client such that said slave client is no longer synchronized with said master client; upon manipulating said initially current view, presenting a synchronization button at said slave client for selection by said follower; and in response to said follower selecting said synchronization button, displaying a second current view, from within said predetermined sequence of views, that is currently displayed at said master client; whereby said slave client is re-synchronized with said master client and rejoins said tour.

In other embodiments, said first current view and said second current view are the same view within said set of predetermined views.

In yet other embodiments, said first current view and said second current view are different views within said set of predetermined views.

Still other embodiment include adjusting the visual prominence of said synchronization button in proportion to the distance between said second current view and the manipulated view at said slave client. In such case, said distance is any of a spatial distance, a temporal distance, an image distance, and a number of moves in said tour as determined by a number of inputs received from said leader.

In other embodiments, said visual prominence is characterized by any of a hue, a saturation, a brightness, a contrast, a blink rate, and a size.

Further, in other embodiments each view within said set of views is determined by any of a rendering viewpoint for said geospatial information, one or more visibilities of layers of said geospatial information.

### BRIEF DESCRIPTION OF THE DRAWINGS

FIG. 1 is a block schematic diagram that shows a system architecture according to the invention;

FIG. 2 is a block schematic diagram that shows session structure according to the invention;

FIG. 3 is a block schematic diagram that shows the structure that is used to establish a session and share data between clients using mailbox channels during a session according to the invention;

FIG. 4 is a storyboard that shows information synchronization according to the invention;

FIG. 5 is a storyboard that shows synchronized control of imagery according to the invention;

FIG. 6 is a storyboard that shows a Sync Button according to the invention;

FIG. 7 is a storyboard that shows distributed collaboration, where imagery is not presented centrally according to the invention;

FIG. 8 is a storyboard that shows a shared environment in which a participant can conceptually disconnect from the group to pursue another path through the imagery; and

FIG. 9 is a block schematic diagram that depicts a machine in the exemplary form of a computer system within which a set of instructions for causing the machine to perform any of the herein disclosed methodologies may be executed.

### DETAILED DESCRIPTION OF THE INVENTION

### Session Structure

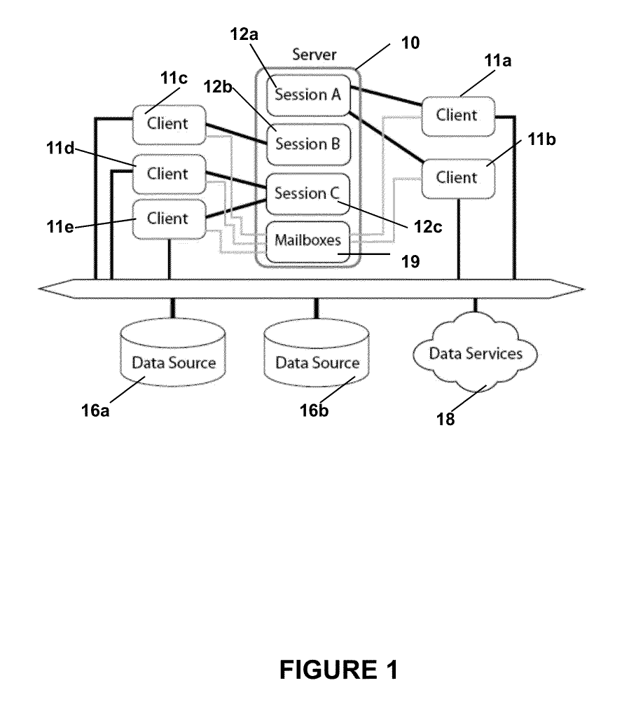

FIG. 1 is a block schematic diagram that shows a system architecture according to the invention. In FIG. 1, a server 10 maintains a plurality of sessions 12a-12c among a plurality of clients 11a-11e, as well as mailboxes 19 for such clients. The clients are communicatively connected to a plurality of data sources 16a, 16b and data services 18.

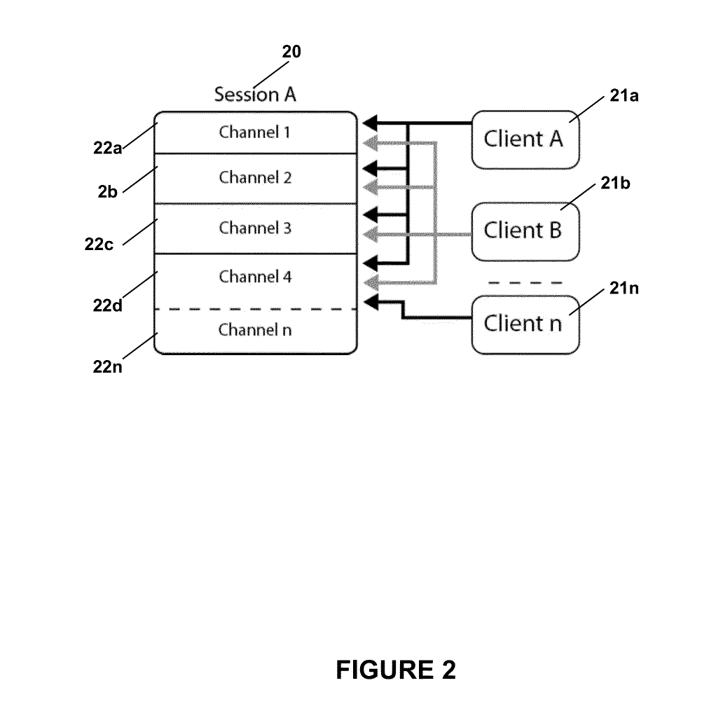

FIG. 2 is a block schematic diagram that shows session structure according to the invention. In FIG. 2, a plurality of clients 21a, 21b . . . 21n are engaged in a session 20 via a plurality of channels 22a, 22b, 22c, 22d, . . . 22n. This aspect of the invention concerns the structure that is used to establish a session and share data between clients during the session. An embodiment concerns sharing data among a plurality of clients by initiating a session with one or more participating clients, establishing one or more channels within said session, allowing one or more of said participating clients to subscribe to each of said channels, and sharing data between said clients via each of said channels.

In a further embodiment, each of said channels is characterized by a channel type, and each of said participating clients uses said type to determines whether it should subscribe to a channel. In further embodiments, the channel type is associated with a data schema.

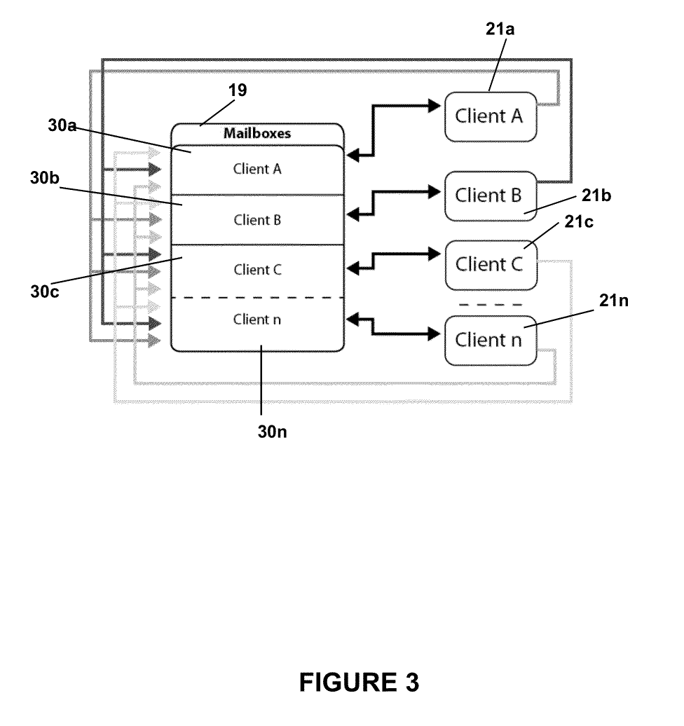

FIG. 3 is a block schematic diagram that shows the structure that is used to establish a session and share data between clients using mailbox channels 19 during a session according to the invention. In embodiments, the channels comprise one or more mailbox channels, wherein each of said mailbox channels is owned by a single participating client 21a, 21b, 21c, . . . 21n among said participating clients, and wherein each of said mailbox channels enables 30a, 30b, 30c, . . . 30n private transmission of data to said single participating client.

In embodiments, the system maintains a list of eligible clients, that, with proper authentication, can join said session as participating clients.

In another embodiment, one or more of said channels exchanges information for controlling the behavior of an application operating on one of said clients, makes a local copy of said state, makes changes to said local copy to produce a forked state, and requests that said server merge said forked state into said state. Further, in such embodiment one of said clients, acting as a session moderator, approves said forked state prior to said server merging said forked state.

In another embodiment, the system maintains a history of prior states. In such case, one or more of said clients can request that said server revert said state to a prior state within said history of prior states; said server maintains said history; and/or one or more of said clients maintains said history.

### Synchronization

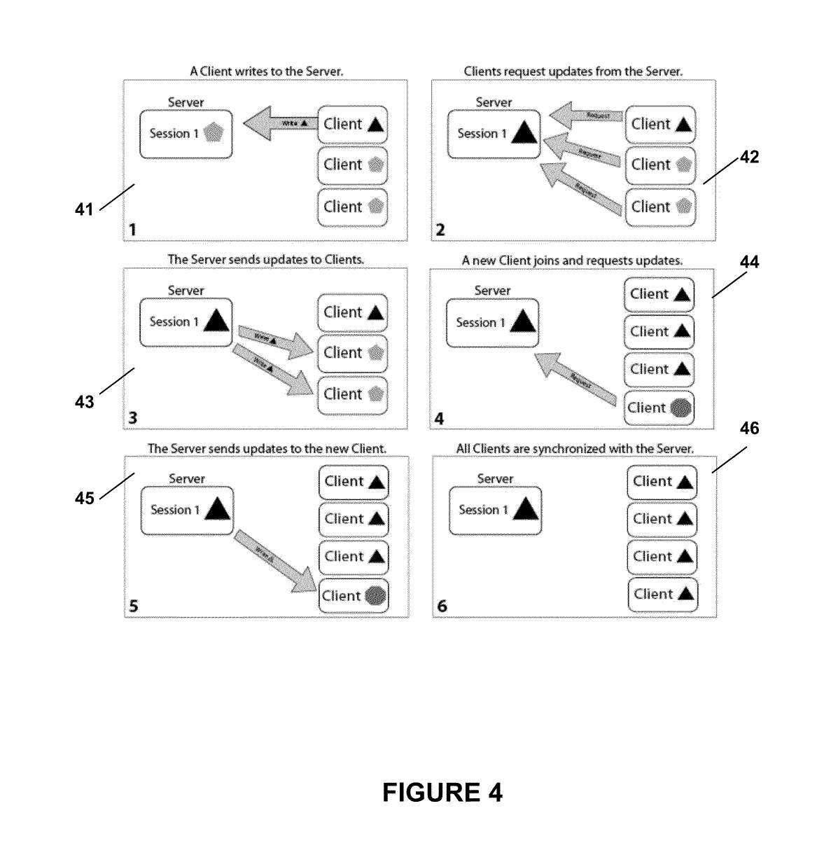

FIG. 4 is a storyboard that shows information synchronization according to the invention. This aspect of the invention concerns the manner in which information is synchronized in the system. An embodiment concerns synchronizing data in a system having a server, one or more clients, and a session maintained by said server. The session is initiated by a first of said clients and maintained by said server, wherein said session is determined by a state comprising one or more key value pairs, wherein any one of said clients can submit changes to one or more of said key-value pairs to said server, and wherein said server propagates said changes to other clients.

As shown in FIG. 4, a Client writes to the Server 41, thus updating the data at the Server; thereafter, the Clients request updates from the Server 42; the Server sends the updates to the Clients 43; thereafter, a new Client joins and requests updates 44; the Server sends updates to the new Client 45; and all of the Clients are now synchronized with the Server 46.

Further, in such embodiment said session is joined by one or more of said clients other than said first of said clients.

In a further embodiment, said changes are propagated in response to polling by said other clients.

In a further embodiment, said server actively notifies said other clients of said changes.

In a further embodiment, any one of said clients can make a local copy of said state, make changes to said local copy to produce a forked state, and request that said server merge said forked state into said state. In such case, one of said clients, acting as a session moderator, approves said forked state prior to said server merging said forked state.

In a further embodiment, said system maintains a history of prior states. In such case, one or more of said clients can request that said server revert said state to a prior state within said history of prior states; said server maintains said history; and/or one or more of said clients maintains said history.

### Synchronized Control of Imagery

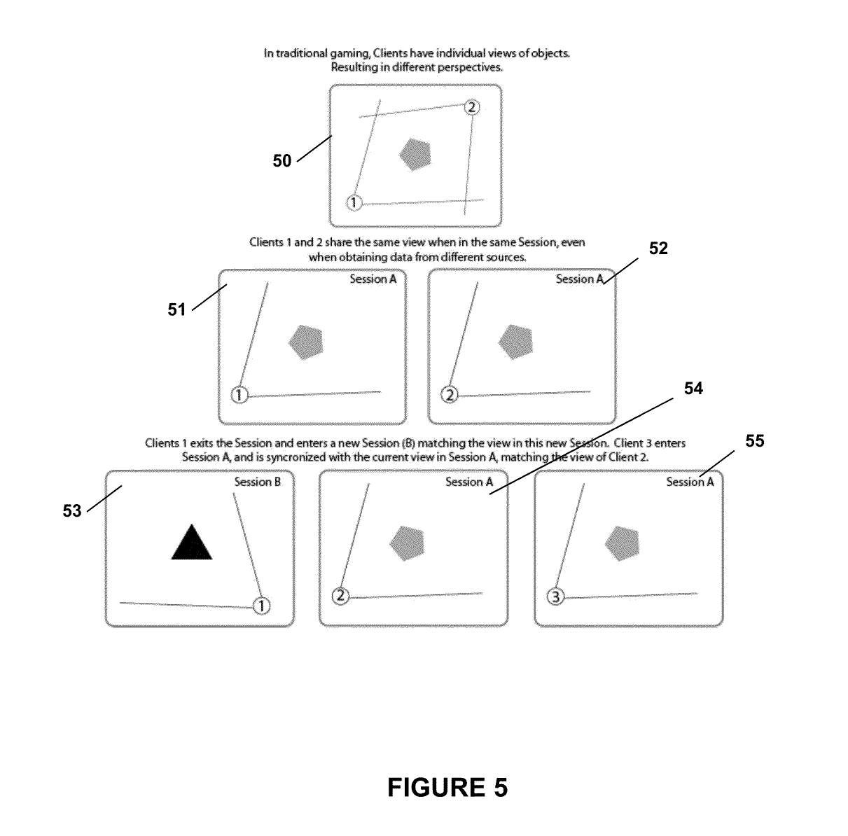

FIG. 5 is a storyboard that shows synchronized control of imagery according to the invention. Many collaborative applications, e.g. video games and desktop conferencing systems, provide a sense of a shared environment with which and within which physically distributed participants can interact. Actions of one participant result in changes within the environment that are replicated within the environment as rendered for each of the other participants. For example, an enemy neutralized by one player in a multiplayer online video game is removed from the shared environment as rendered for all players. Similarly, words written on a virtual whiteboard by one participant within a desktop conference are visible on the virtual whiteboard as rendered for all participants. The herein disclosed system provides similar functionality for a shared environment in which physically distributed users explore geospatial information in a synchronized manner. Specifically, a user can annotate the displayed information, and the resulting annotations can be viewed by other participants. However, the herein disclosed system provides a deeper sense of collaboration by providing the participants with synchronized navigational control of the geospatial information. Control inputs, e.g. pans, zooms, or rotations, of one user synchronously update the viewpoint of other users. In the case of the herein disclosed system, the viewpoint most directly corresponds to so-called camera parameters, e.g. location, orientation, and angular field of view, used in rendering the geospatial information. However, for purposes of the invention herein, a viewpoint also includes such things as the visibility of imagery layers, a particular Web page within a series of web pages, e.g. a website, an active slide within a Web presentation, and a current region of interest within a document, e.g. an image file.

Accordingly, in FIG. 5 it can be seen that in traditional gaming, Clients have individual views of objects, resulting in different perspectives 50. In an embodiment of the invention, Clients 1 and 2 share the same view 51, 52 when in the same Session (A), even when obtaining data from different sources. Client 1 can exit the Session and enter a new Session (B) 53 that matches the view in the new session. Likewise, Client 3 can enter Session A 55 and is synchronized with the current view in Session A, thus matching the view of Client 2 (54).

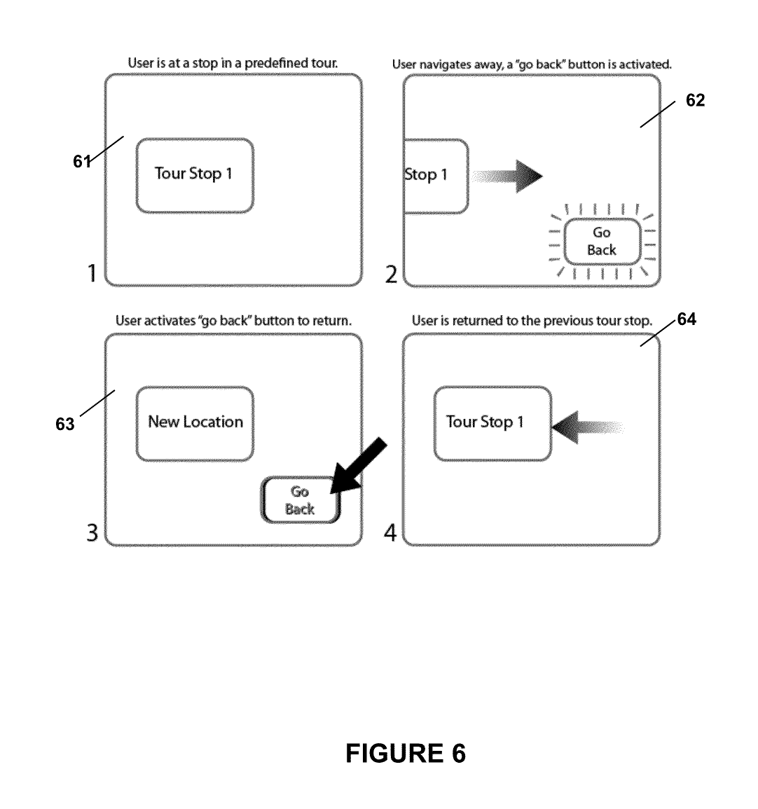

FIG. 6 is a storyboard that shows a Sync Button according to the invention. Thus, another aspect of the invention concerns a Sync Button that allows a follower of a tour, to deviate from a particular view within the tour. Upon pressing the button, the follower is immediately returned to the then current view within the tour. This allows the follower to explore the area surrounding a tour stop independently without fear of being irrevocably dropped from the tour. For purposes of the invention herein, views include, inter alia, slides or other discretely sequential AV materials in a video conference Web meeting.

Accordingly, in FIG. 6 the User is at a stop in a predefined tour 61; the User navigates away from the tour, for example by panning the map, a “go back” button appears 62; the User again activates the “go back” button to return to the tour 63; and the User is then returned to the previous tour stop 64.

In an embodiment, the predefined tour can be thought of as a list of bookmarks, which are referred to as tour stops. A user interface element is used to navigate through the list. Tour stops contain several types of information, such as a camera view on the map, associated layer information, and information to display on auxiliary displays. In the simplest example, the user interface element has a button to go to the previous tour stop, and a button to go the next tour stop.

For example:
1) Tour stop one: San Francisco;
2) Tour stop two: San Jose; and
3) Tour stop three: Los Angeles.

The user starts the tour, and immediately goes to the first stop, San Francisco. By hitting the ‘next’ button, the user is taken to San Jose. At this point, the ‘previous’ button becomes active. Tapping the ‘previous’ button takes the user back to San Francisco. If the user is at the San Jose tour stop, hitting the ‘next’ button takes the user to ‘Los Angeles’.

This embodiment of the invention concerns that inventive insight that during a discussion, a group tends to explore the areas surrounding a tour stop. For example, let's say the group goes to the San Jose tour stop. A user in the group may pan the map to look at Palo Alto. In this case, the system indicates to the group that they are ‘out of sync’ with the tour, i.e. they are not at a tour stop, by displaying a ‘Go Back’ button. Tapping the ‘Go Back’ button takes the group back to the current tour stop, in this case ‘San Jose,’ a known point of the presentation.

Note that this aspect of the invention is different from ‘Previous’, which would take the group back to San Francisco. The reason that this is important is that it allows tangent exploration without having to leave the context of the current tour stop. A given tour stop may have associated with it a large amount of information, such as a highlighted list of rental properties or several support documents on supporting displays. ‘Go Back’ or returning to the current tour stop does not force an unintended information context switch.

Also, this aspect of the invention is different than ‘Wander Away’ which is discussed in greater detail below. ‘Wander Away’ is for the case where a participant is in a moderated session. The ‘Go Back’ idea is used both in standalone and networked situations. In other words, a moderator in a network session may use this tour list mechanism as described to give a presentation, using the ‘Go Back’ button to return to the current tour stop if the moderator's group navigates away from the tour stop. A single user on a standalone system may use the ‘Go Back’ mechanism analogously.

Participant clients use the ‘Wander Away’ facility only during moderated, networked sessions to rejoin a tour at the point where the moderator presentation currently is located. For example, consider the situation where a moderated session has just arrived at tour stop two, San Jose. A participating client “wanders away” to examine some industrial real estate surrounding the airport. The clients ‘Synch’ button appears. In the meantime, the moderator has navigated to Palo Alto. The moderator's ‘Go Back’ button appears, indicating that the moderator is not at a tour stop location.

At this point, if the participant activates ‘Synch,’ the participant's display would synchronize with the moderator's, and reflect the same Palo Alto display. The participant changes to reflect the current moderator state. In practice, ‘Synch’ can also be thought of as ‘Rejoin’ when the participant wanders away. If, instead, the moderator had hit ‘Go Back’ and returned to the San Jose tour stop before the participant had hit the ‘Synch’ button, and then the participant hit the ‘Synch’ button, the participant's display would synchronize with the moderator's to reflect the same San Jose display.

This embodiment of the invention provides synchronized display of geospatial information. This includes loading a tour comprising a set of predetermined views of said geospatial information; receiving inputs from a leader operating a master client; receiving inputs from a follower operating a slave client; in response to said inputs from said leader, displaying in a synchronized manner, a first current view, from within said set of predetermined views, at said master client and said slave client; in response to said inputs from said follower, manipulating said initially current view at said slave client such that said slave client is no longer synchronized with said master client; upon manipulating said initially current view, presenting a synchronization button at said slave client for selection by said follower; and in response to said follower selecting said synchronization button, displaying a second current view, from within said predetermined sequence of views, that is currently displayed at said master client; whereby said slave client is re-synchronized with said master client and rejoins said tour.

In other embodiments, said first current view and said second current view are the same view within said set of predetermined views.

In yet other embodiments, said first current view and said second current view are different views within said set of predetermined views.

Still other embodiment include adjusting the visual prominence of said synchronization button in proportion to the distance between said second current view and the manipulated view at said slave client. In such case, said distance is any of a spatial distance, a temporal distance, an image distance, and a number of moves in said tour as determined by a number of inputs received from said leader.

In other embodiments, said visual prominence is characterized by any of a hue, a saturation, a brightness, a contrast, a blink rate, and a size.

Further, in other embodiments each view within said set of views is determined by any of a rendering viewpoint for said geospatial information, one or more visibilities of layers of said geospatial information.

### Architecture

Sessions. As with known collaboration systems, embodiments of the invention allow cooperation of multiple participants in one or more live on-line sessions. The invention allows participants to invite other participants into a session. With the invention, the session typically centers on a geographic presentation, such as an annotated satellite view of a city or the like. For example, during a session a participant may want to go look at a point of interest within the presentation, such as the Port of Los Angeles, and the participant may draw the attention of the other participants to this feature on a main screen in a multi-screen display, where each screen can represent a session. Participants on one screen can then be invited to join the session of the main screen, and so on. Thus, an embodiment of the invention provides a relatively inexpensive way to control a lot of screen real estate. While embodiment concern large displays, most likely participants in a session according to the invention typically have either a very direct connection to session, or participate at a level of indirection, for example as window placements on a display surface.

Metadata. The local capabilities or the local files of each participant participate in a session based on the session metadata that they receive. If a particular participant does not have the capability to exhibit a certain view, the view is approximated or tracked to the best of the local display ability for the participant. A first aspect of the invention, therefore, concerns a major distinction between state of the art collaboration systems, which use a central server to process all imagery and serve images to each participant, thereby consuming excessive amounts of processor power at the server and bandwidth between the participants, with resulting latency, and the invention, which allows each participant to effect changes to local imagery and pass these changes to each other participant in the form of metadata that is interpreted locally at each other participant display in accordance with local capability.

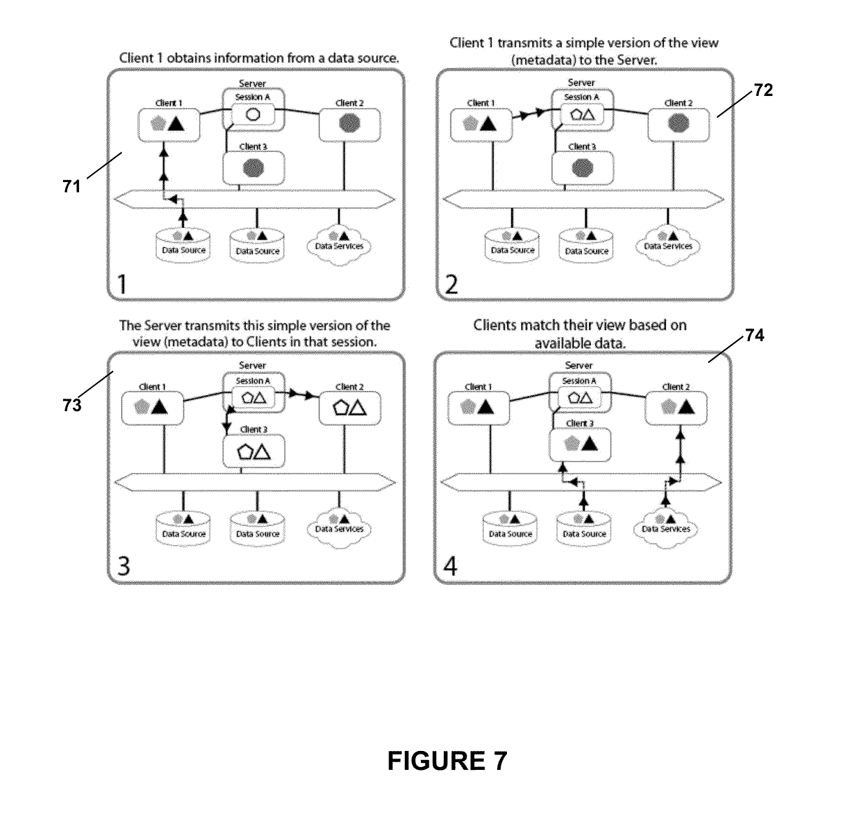

FIG. 7 is a storyboard that shows distributed collaboration, where imagery is not presented centrally according to the invention. If a participant does not have the capability to reproduce another participant's display, the participant display can ignore the metadata in general or can interpret it within the scope and resolution of the local display. For example, in a geospatial environment, a participant display with a 2D map representation can still zoom, pan and, perhaps even effect tilt of the earth of a 3D globe participant. Thus, participant displays may not necessarily exactly mirror each other identically, but still describe the same view from a similar translated perspective. As such, the invention both provides distributed collaboration, where imagery is not presented centrally, and accommodates different displays that have different resolutions while providing the closest approximation of the session image and changes to that image from multiple participants during the session.

Accordingly, in FIG. 7 Client 1 obtains information from a data source 71; Client 1 transmits a simple version of the view, e.g. metadata, to the Server 72; the Server transmits this simple version of the view, i.e. the metadata, to the other Clients in that session; and the Client match their view based upon the available data.

Channels. One way to handle the different capabilities of the various participants, i.e. subscribers, to this shared information is through this notion of channels, where different channels allow the exchange of information for different capabilities. Not all participants have to subscribe to all channels, participants may subscribe to channels on a know how to handle basis.

Synchronization. Embodiments of the invention concern synchronization. For example, suppose a series of movies are presented daily, perhaps rushes from a film in production, and it is desirable to go back and review these movies collectively as a group. In such a case, the participants join the same Session. One participant in the group may navigate to a particular movie time; the movie on each participant's display synchronizes to that movie time. When one participant starts the movie, all participants' movies start playing. Analogously, each participant can stop the movie; they can use tools to draw on the movie at a particular point in time, and perform other movie manipulation tasks in a synchronized manner. Each participant action provides to each other participant metadata relating to the action taken, containing all of the references to a movie database, for example, and thus provides channels of information that can be used to store information regarding a common image concurrently. In such case, the notion is not one of temporality, although participants traverse the movie in time, but of storing different types of information, e.g. channels. Another example concerns an architect, where there is a 3D model of a building in the participant display space, and where the metadata generated by each participant controls the look of the model simultaneously from different locations, where each location may have different capabilities.

Thus, embodiments of the invention concern the visualization of relatively complex data sets and the simultaneous synchronization, visualization, and manipulation of such data sets across both a network and to different areas having different capabilities. Such data sets arise pursuant to one or more sessions, in which data set synchronization occurs across a network, more or less simultaneously in different areas, using the same data sets, but possibly from different perspectives among a group of session participants.

One feature of a session is the provision of a moderation mode. Normally any participant may navigate the shared view at any time. However, there are other times when a participant may want to provide a briefing, where such participant does not want anybody to interrupt him. In the state of the art, as evidenced for example by GoToMeeting, a given participant's client sharing their stream via a server that is accessed by the other participants' clients. In effect, a screenshot from a particular participant's client is broadcast to the server and that screenshot is provided to every other participant's client, and they can see it. In the case of the invention, this approach is difficult to use because no one is assured of all bandwidth necessary at each one of the client endpoints to receive the screenshot in real time as it is modified.

Accordingly, embodiments of the invention herein provide a synchronization server, in which the client of a participant who is controlling the session sends out metadata of the session, and the server distributes it to the client of every other participant in the session. For example, a participant looks at LA City Hall, and does so by geographic coordinate. Thus, this participant's client places a camera up above the LA City Hall, and the system passing metadata to the other participants with regard to such actions as pan or tilt. In this embodiment, only the amount of data necessary to provide this coordinate information is sent this server for distribution to the other participants in the session.

Because the system sends control signals, i.e. the metadata, to each of the participants, the platform and the software and so forth of each participant can be different. The server itself does not have to maintain a mapping table to provide appropriate translation of the various control signals for each destination. Rather, the translation can be done in the clients themselves. In a presently preferred embodiment, the metadata is defined to be platform-agnostic, i.e. it contains all the information that the clients need to translate in and out of the formats they need. For example, consider a view in Google Earth in Cartesian space, i.e. an X, Y, Z coordinate system. In such case, the system sends those coordinates in a named order that corresponds to certain axes directions. The clients each generate a standard form control signal. Once such signal is received at a client, the client knows what it needs to do with that information and controls the local display. In other embodiments, the system keeps track of the capabilities of a given client, e.g. where the participant display is an iPad versus a 3D display.

Moderator. A significant difference between the invention herein and such state of the art solutions, such as GoToMeeting, is that the server in embodiments of the invention, i.e. the session management function that establishes the role of the moderator, receives just the metadata. It does not maintain an image, it does not have to maintain a record of what is going on. It is just passing signals back and forth to every participant in the session and, with regard to priority, to a master if there is a master, in which case it knows the identity of the master. If a master is not designated, e.g. the session is an ad hoc session, then the server simply sends every signal to every participant. There are some things that are kept on the server, referred to herein as savable objects, e.g. a history for a drawing session comprising all of the drawing commands concerning the state of the drawing. As such, the invention does not create latency or bandwidth issues, and can provide a very quick response time in a session. Whether a participant has a very slow data links to a remote place, or has access to very fast local resources, the session synchronization technique herein disclosed use very little bandwidth.

Disparate Clients. In contrast to the state of the art, the invention herein is concerned with trying to synchronize state, and not with trying to have an exact representation of a document or image for each session participant. For example, if in a session the participants want to look at a metacarpal on an MRI, each participant can look at that together because each participant already has that information locally, or has access to such information independently of the session server. The participants do not have to go ahead and find the metacarpal because the metadata exchanged between the participants directs the local presentation to allow the participant to look at that particular place in the MRI or local version of the session imagery, e.g. an X-ray. In the metacarpal example, one participant may be a radiologist who only has the X-rays available, but then another participant has an MRI available. If the two clients for these participants could perform appropriate translations in their coordinate systems to look at the same location in the body of the person in question, then the radiologist who only has the X-ray could be looking at the X-ray, whereas the other participant could be looking at the MRI. They could be collaborating with each other, and maybe something showing on the X-ray does not show on the MRI, or vice versa. That is, they could be collaborating on different sets of data but about the same thing. In state of the art approaches it is not possible to do that. The person who is hosting the meeting has to have all the data available, or else collaborating is difficult.

Coordinate System. Accordingly, one key feature of the invention is the use of a coordinate system to set references in various depictions of common material. In some cases it is a special coordinate, such as a center view and other things. In the case of the medical example, it is an anatomical location. In each case, there is a location, but the location is defined very differently. Location does not necessarily mean geographic location. For example, in raw footage studio editing, there is a timeline, i.e. temporal location, in relation to the footage, but it is not a geographic location. Thus, the invention shares points of reference around a common basis, where the common basis has a plurality of locations that are referenced by a common coordinate system, with each participant having a locally disparate database that is accessed in connection with the above-mentioned metadata to present the shared reference locally. In this way, the invention solves the latency problem. Further, the metadata are agnostic with regard to each participant's client and thus supports disparate platforms, where each platform has a different database.

Thus, collaboration during a session yields a reference in the form of metadata to synchronize the session display to a particular set, for example wherever the current moderator has left the field of view. In the case of Los Angeles, the participants go to Los Angeles, begin to display the appropriate imagery, and load the appropriate metadata during the session to modify the imagery.

Storage. Participant storage of data can comprise both the session-related metadata that is received during the session by the client and, because the client also has the option of storing other types of data, such as local line drawings or annotations, at a central server and have it shared with each of the other participant, instead of storing it locally, or in addition to storing it locally. One aspect of this storage capability is that a session can be stored for later use, for example by storing and/or distributing links to information, or by providing a data silo where each participant's data is synchronized.

Multiple Sessions. The system herein disclosed is not limited to one session, but can have multiple sessions. For purposes of the discussion herein, a session comprises information that is stored in one or more channels. The channels are created by the clients to provide an information medium. For example, there can be a channel referred to as ‘camera’ which has a predefined dictionary of camera information, e.g. using an open GL coordinate description. In a dictionary, e.g. for Google Earth, each client understands a subset of keys and, for example, ESRI ArcGIS clients understand another subset of keys. Each of the clients can maintain keys in the dictionary that other clients do not understand without destroying the data structure because it is possible to keep adding keys to the dictionary, while maintaining the integrity of the dictionary. Those keys that a particular client understands are used by the client, while those that are not understood are ignored by that client.

Thus, there can be a channel for a camera that allows changes in perspective on a map, a channel for drawing, and a channel for annotations, etc. that can be added dynamically. If a participant wants to create a channel, the participant requests a new channel, and the system provides a newly created channel. Other participants may register to be notified of such events so that the metadata for that channel can then be requested from the system. In the dictionary, the system can add keys to the dictionary and then tell each participant's client that a key has created, updated, or removed, but the system does not analyze the value part of the dictionary, it just passes the metadata on to the clients, and the client looks at the dictionary.

In some embodiments, there are autonomous clients, e.g. bots, that run on the system server or anywhere else and that look for a specific condition or set of conditions or states on one or more channels and take an action when the condition and/or state is detected.

Shared State. The shared basis is the set of channels, essentially comprising a common language and the means by which the system describes state during the session and what each participant has in common. Each session is a current state comprising a shared state. Multiple sessions can exist with regard to the same world, but each session describes a current state of that world. Thus, a session represents a community of interest or account of focus among a group of participants who wish to share a synchronized view into this world. Put a different way, a session is a perspective on a given subject matter. Sessions can be recorded and revisited, and sessions can be merged or broken apart.

Key Value Pairs. A session can also be thought of as a state of key value pairs that define a shared view and/or shared reference point into the session subject matter. Sessions can be organized hierarchically, for example there can be a master session that is broken down into subsessions, such that participants can start a task, go back, break it off into subtasks, amalgamate all that data, bring it back into the master session, and get the results to the decision-makers. Thus, while a master session is taking place, another session could be created underneath it that could then come up with a master that would then come back into that session. For example, suppose that at the All-Star Game there is a bomb threat and it is necessary to know the evacuation plans for the Staples Center. The command center would instruct the LAPD to figure out what those plans are and then bring them back into the command center so they can actually disperse that as the plan of action. They could use real-time imagery based on, for example, helicopter observing a crowd, so that the response might be different depending on particular circumstances. Rather than have a general evacuation plan, they could actually build a real-time evacuation plan because there could be a session that could go off and determine what are the situations on the ground right now, and then apply that to the evacuation plan in another area, and bundle that all up into a current session.

Thus, embodiments of the invention concern the notion of exchanging metadata from a server, storing information on the server, sessions, and channels which speak to each platform in form of the platform's dictionary for the channel and key off of that dictionary to create some kind of change at the level of the platform.

Wander Away. Another embodiment of the inventions allows a participant to wander away from a session and then re-sync to the session. For example, the session concerns an on-line campus tour in Wisconsin. One participant chooses to wander away from the tour area and the system provides that participant with a control that alerts the participant that he wandered away and inquires whether or not the participant wants to re-sync with the tour. If the participant selects the control, the participant is taken back to the tour.

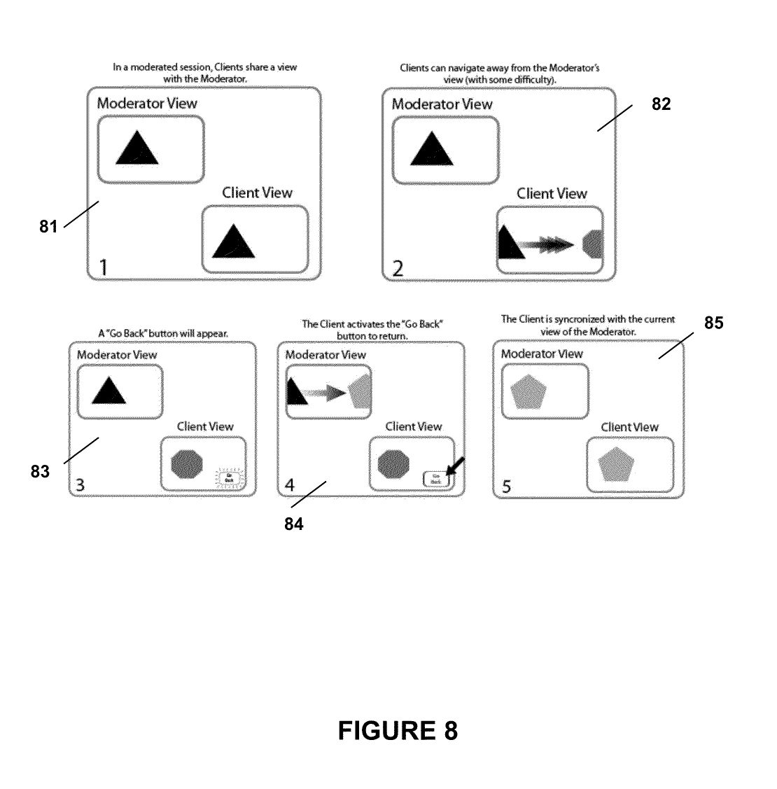

FIG. 8 is a storyboard that shows a shared environment in which a participant can conceptually disconnect from the group to pursue another path through the imagery. Thus, in a shared environment a participant can conceptually disconnect from the group to pursue another path through the imagery, for example, and then join the group again. In another embodiment, the group wants the wayward participant to return to the session and an alert is provided to that participant to that he is needed and should rejoin the session. When a participant wanders away, the group can receive an alert that indicates that a particular participant has wandered away, e.g. an icon on the screen, or a red dot where that participant's is displayed in a list of participant names. Thus, each individual can be a participant in a guided, shared session, but at the same time they can go out and wander off. Thus, there is the notion of the session's trajectory coinciding with the trajectory of the moderator which provides a current shared perspective in the session, and yet each participant also the ability to explore the same space, but from a different perspective, and rejoin the group perspective. From a state point of view, a participant who wanders away stops sending updates to the system, which would otherwise become shared metadata.

Accordingly, in FIG. 8 there is a moderated session in which a plurality of Clients share a view with the Moderator 81; the Clients can navigate away from the Moderator's view, in some cases perhaps with some difficulty 82; in this case, a “go back” button is provided to the Clients that have navigated away from the Moderator's view 83; the Clients activate the “go back” button to return 84; and the Clients are synchronized with the current view of the Moderator 85.

In such embodiment, a session can include a picture or mosaic that shows to where each participant is wandering, and if everybody finds it interesting then they could jump in and that could be a new session or, if everybody wanders away, then there is a mosaic to where everybody is wandering. There could be an explore mode, but the original session would still be maintained.

Such embodiment also allows each participant to create more information to show to other participants. Not only can a participant rejoin the group, a participant can bring the group over to another place that has interesting things. The genesis of this is a real-time map, where people are actually walking. They may go and snap a picture on their phone and upload it and leave annotations asking others to look at the picture. Thus, this embodiment concerns the idea of not only seeing what people have added, but where other people are looking in the same session to find items of interest. Part of this would allow a map of maps that shows where everybody is and what they are looking at. Thus, the session comprises participants who are both trying to share data that is in that session and then there is a perspective that participants are trying to share with other participants.

This embodiment also comprehends the notion of homogenizing the information. Every time somebody does something, the scene is adjusted so that everybody is always getting updated to the same thing; and there is the notion that we can separately track the actions of different people with regard to it, so that each participant can see all the different perspectives. In a military application, soldiers can take pictures with their phones of where they're attacking or reconnoitering, for example, and upload the images into a session, where the commander can review and explore. Thus, one can preserve the session on the display and break out a portion of the display for a wander away, for example. So, the commander in this example can keep an eye on what's going on while they're exploring.

### Computer Implementation

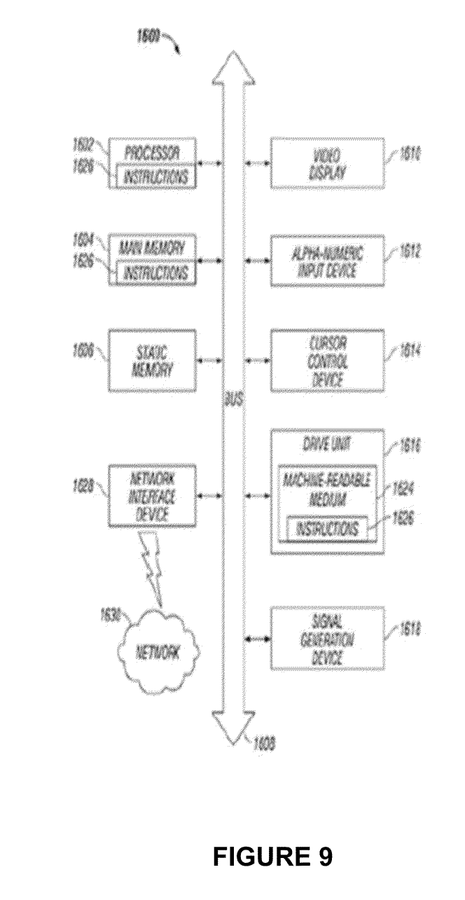

FIG. 9 is a block schematic diagram that depicts a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for visualization of complex data sets and simultaneous synchronization of such data sets across both a network and to different areas having different capabilities, comprising:
a processor establishing a session in a system having a server, one or more clients, and a session maintained by said server, said session having a structure and sharing data between a plurality of clients during said session by initiating a session with one or more participating clients, establishing one or more channels within said session, allowing one or more of said participating clients to subscribe to each of said channels, and sharing data between said clients via each of said channels;
wherein each of said channels comprises a channel type, and each of said participating clients uses said channel type to determine whether it should subscribe to a channel; and
wherein one or more of said channels exchanges information for controlling state of an application operating on one of said clients, makes a local copy of said state, makes changes to said local copy to produce a forked state, and requests that said forked state be merged into said state.

2. The method of claim 1, wherein said channel type is associated with a data schema.

3. The method of claim 1, wherein channels comprise one or more mailbox channels, wherein each of said mailbox channels is owned by a single participating client among said participating clients, and wherein each of said mailbox channels enables private transmission of data to said single participating client.

4. The method of claim 1, further comprising:
maintaining a list of eligible clients, that, with proper authentication, can join said session as participating clients.

5. The method of claim 1, wherein one of said clients, acting as a session moderator, approves said forked state prior to said merging said forked state with said state.

6. The method of claim 1, further comprising:
maintaining a history of prior states, wherein one or more of said clients can request reversion of said state to a prior state within said history of prior states;
wherein any of a server and one or more of said clients maintains said history.

7. The method of claim 1, further comprising:
synchronizing data in a session initiated by a first of said clients and maintained by said server;
wherein said session is determined by a state comprising one or more key value pairs;
wherein any one of said clients can submit changes to one or more of said key-value pairs to said server; and
wherein said server propagates said changes to others of said clients.

8. The method of claim 7, wherein said session is joined by one or more of said clients other than said first of said clients.

9. The method of claim 7, wherein said changes are propagated in response to polling by said other clients.

10. The method of claim 7, wherein said server actively notifies said other clients of said changes.

11. The method of claim 7, wherein any one of said clients can make a local copy of said state, make changes to said local copy to produce a forked state, and request that said server merge said forked state into said state;
wherein one of said clients, acting as a session moderator, approves said forked state prior to said server merging said forked state.

12. The method of Clam 1, further comprising:
maintaining a history of prior states;
wherein one or more of said clients can request that said server revert said state to a prior state within said history of prior states; and
wherein any of said server and one or more of said clients maintains said history.

13. A computer implemented method for synchronized control of imagery, comprising:
providing a shared environment in which physically distributed users explore geospatial information in a synchronized manner, and in which each user can annotate displayed information, and resulting annotations can be viewed by others of said users;
providing said users with synchronized navigational control of said geospatial information, wherein control inputs of one user synchronously update a viewpoint of said other users; and
wherein said viewpoint corresponds to camera parameters, comprising any of location, orientation, and angular field of view, used in rendering said geospatial information.

14. The method of claim 13, wherein viewpoint also comprises any of visibility of imagery layers, a particular Web page within a series of Web pages, an active slide within a Web presentation, and a current region of interest within a document.

15. A computer implemented method for restoring synchronization to a predefined virtual tour, comprising:
providing a control that allows a follower of a tour comprising two or more stops to deviate from a particular stop within said tour;
wherein upon operating said control, said follower is immediately returned to any of a then current stop within said tour, a previous stop in said tour, and a next stop in said tour;
wherein said follower can explore an area surrounding a tour stop independently of said tour.

16. A computer implemented method for restoring synchronization to a predefined virtual tour, comprising:
providing a control that allows a follower of a tour, led by a presenter, to deviate from a particular view within said tour;
wherein upon operating said control, said follower is immediately returned to a then current view within said tour, as determined by a then current location in said tour of said presenter;
wherein said follower can explore an area surrounding a tour stop independently without being irrevocably dropped from said tour.

17. A computer implemented method for providing synchronized display of geospatial information, comprising:
a processor loading a tour comprising a set of predetermined views of said geospatial information;
receiving inputs from a leader operating a master client;
receiving inputs from a follower operating a slave client;
in response to said inputs from said leader, displaying in a synchronized manner, a first current view, from within said set of predetermined views, at said master client and said slave client;
in response to said inputs from said follower, manipulating said initially current view at said slave client, wherein said slave client is no longer synchronized with said master client;
upon manipulating said initially current view, presenting a synchronization button at said slave client for selection by said follower; and
in response to said follower selecting said synchronization button, displaying a second current view, from within said predetermined sequence of views, that is currently displayed at said master client;
whereby said slave client is re-synchronized with said master client and rejoins said tour.

18. The method of claim 17, wherein said first current view and said second current view are a same view within said set of predetermined views.

19. The method of claim 17, wherein said first current view and said second current view are different views within said set of predetermined views.

20. The method of claim 17, further comprising:
adjusting a visual prominence of said synchronization button in proportion to a distance between said second current view and a manipulated view at said slave client;
wherein said distance is any of a spatial distance, a temporal distance, an image distance, and a number of moves in said tour as determined by a number of inputs received from said leader.

21. The method of claim 20, wherein said visual prominence is characterized by any of a hue, a saturation, a brightness, a contrast, a blink rate, and a size.

22. The method of claim 17, wherein each view within said set of views is determined by any of a rendering viewpoint for said geospatial information and one or more visibilities of layers of said geospatial information.
